(19) United States
(12) Patent Application Publication
(10) Pub. No.: US 2009/0318164 A1
(43) Pub. Date: Dec. 24, 2009

(54) METHOD AND SYSTEM FOR GNSS-ASSISTED CALL SIGNALING AND MULTIMEDIA SERVER ASSIGNMENT

(76) Inventor: Tommy Wing Chau Kee, Richmond (CA)

Correspondence Address: MCANDREWS HELD & MALLOY, LTD, 500 WEST MADISON STREET, SUITE 3400, CHICAGO, IL, 60661, US

(21) Appl. No.: 12/191,728

(22) Filed: Aug. 14, 2008

Related U.S. Application Data
(60) Provisional application No. 61/073,946, filed on Jun. 19, 2008.

(51) Int. Cl. H04Q 7/20

(52) U.S. Cl. 455/456.1

(57) ABSTRACT

Aspects of a method and system for GNSS-assisted Call Signaling and Multimedia server assignment may include determining a location of an IP endpoint device and a location of each of a plurality of proxy servers and/or media servers, wherein at least the location of the IP endpoint device may be determined via a Global Navigation Satellite System (GNSS). A proxy server and/or media server may be assigned to be a serving server from the plurality of proxy servers and/or media server, for one or more multimedia services for an IP endpoint device, wherein the assigning may be based on at least the determined location of the IP endpoint device and the locations of the plurality of proxy servers and/or media servers. The GNSS may be the Global Positioning System (GPS), for example. The IP endpoint device may be a mobile device and/or a fixed device, for example.

### CROSS-REFERENCE TO RELATED APPLICATIONS/INCORPORATION BY REFERENCE

This application makes reference to, claims priority to, and claims the benefit of U.S. Provisional Application Ser. No. 61/073,946, filed on Jun. 19, 2008.

The above referenced application is hereby incorporated herein by reference in its entirety.

### FIELD OF THE INVENTION

Certain embodiments of the invention relate to signal processing for communication systems. More specifically, certain embodiments of the invention relate to a method and system for GNSS-assisted Call Signaling and Multimedia server assignment.

### BACKGROUND OF THE INVENTION

Increasingly, packet-based networks may be used to carry real-time data traffic, which is sensitive to delays that may occur due to the packet-based nature of many network architectures. With the almost universal availability of personal computers and Internet access, real-time voice, video and data services have increasingly moved away from purpose-built, circuit-switched networks to general purpose packet-based networks. Management of delays in speech services, for example, may be important to ensure that voice services may be perceived of quality.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for GNSS-assisted Call Signaling and Multimedia server assignment, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary wireless communication system, in accordance with an embodiment of the invention.

FIG. 2 is an exemplary distributed VoIP network topology, in accordance with an embodiment of the invention.

FIG. 3A is a flow chart illustrating an exemplary POE-S based server assignment protocol, in accordance with various embodiments of the invention.

FIG. 3B is a flow chart illustrating an exemplary IP endpoint device based server assignment protocol, in accordance with various embodiments of the invention.

### DETAILED DESCRIPTION OF THE INVENTION

Certain embodiments of the invention may be found in a method and system for GNSS-assisted Call Signaling and Multimedia server assignment. Aspects of a method and system for GNSS-assisted Call Signaling and Multimedia server assignment may comprise determining a location of an IP endpoint device and a location of each of a plurality of proxy servers and/or media servers. At least a location of the IP endpoint device may be determined via a Global Navigation Satellite System (GNSS). A proxy server and/or media server may be assigned to be a serving server from the plurality of proxy servers and/or media servers, for one or more multimedia services for an IP endpoint device. The assigning may be done based on at least the determined location of the IP endpoint device and the locations of the plurality of proxy servers and/or media servers. The GNSS may be the Global Positioning System (GPS), for example. The IP endpoint device may be a mobile device and/or a fixed device, for example. A proxy server and/or media server that may be closer to the IP endpoint device than any other one from the plurality of proxy servers and/or media servers may be assigned as the serving server. The closer proxy server and/or media server may be determined based on straight-line location separation distance between the proxy server and/or media server and the IP endpoint device. The multimedia services may be controlled via Session Initiation Protocol (SIP) signaling. The proxy server may be a Session Initiation Protocol (SIP) Registrar and/or a SIP Proxy server. The serving server may be selected at a point-of-entry server. The serving server assignment may be performed at the IP endpoint device or at one or more of the plurality of proxy servers.) The assignment may be done based on, for example, a round-trip-delay and/or a congestion measure. At least the location of the IP endpoint device may be requested and/or received from the IP endpoint device.

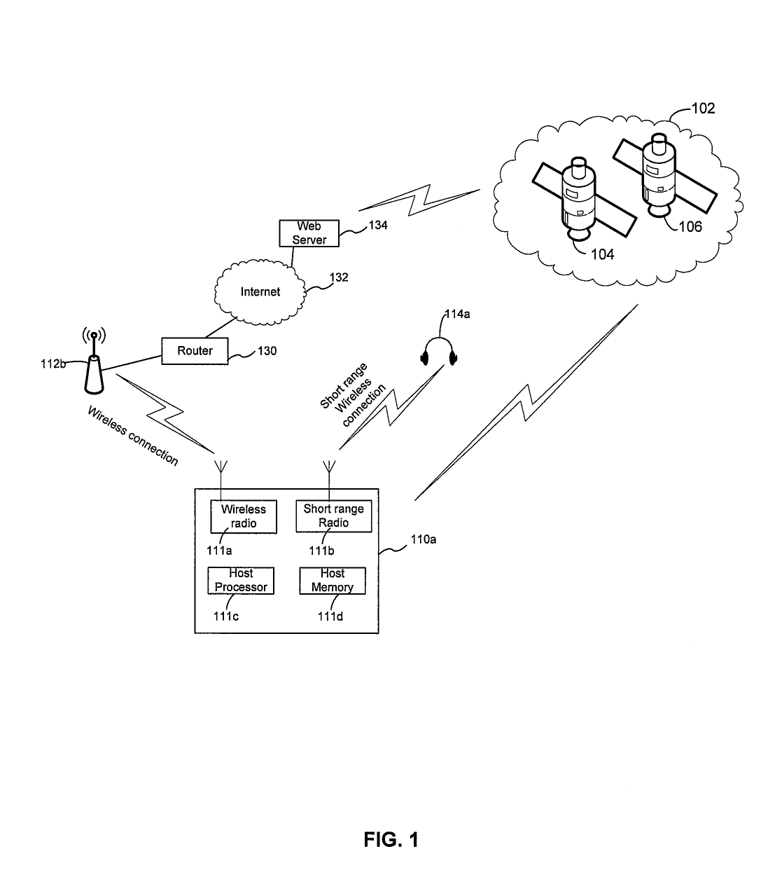

FIG. 1 is a diagram illustrating an exemplary wireless communication system, in accordance with an embodiment of the invention. Referring to FIG. 1, there is shown a Global Navigation Satellite System (GNSS) 102, an access point 112b, a computer 110a, a headset 114a, a router 130, the Internet 132 and a web server 134. The computer or host device 110a may comprise a wireless radio 111a, a short-range radio 111b, a host processor 111c, and a host memory 111d. The GNSS 102 may comprise a plurality of satellites, for example satellites 104 and 106. There is also shown a wireless connection between the wireless radio 111a and the access point 112b, and a short-range wireless connection between the short-range radio 111b and the headset 114a, and a plurality of wireless connections from the GNSS 102 to one or more receiving devices, for example host device 110a and web server 134.

The GNS 102 comprising a plurality of satellites, for example 104 and 106, may comprise suitable logic, circuitry and/or code that may be enabled to transmit data signals via radio-frequency that may carry information suitable to assist a receiving device in establishing its own position. For example, the GNS 102 may be the Global Positioning System (GPS).

Frequently, computing and communication devices may comprise hardware and software to communicate using multiple wireless and wired communication standards, for example Wireless LAN (WLAN 802.11), General Packet Radio Service (GPRS), Wideband Code Division Multiple Access (WCDMA), and Digital Subscriber Line (DSL). The wireless radio 111a may be compliant with one or more mobile communications standard and one or more GNSS standard, for example. There may be instances when the wireless radio 111a and the short-range radio 111b may be active concurrently. For example, it may be desirable for a user of the computer or host device 110a to access the Internet 132 in order to consume streaming content from the Web server 134. Accordingly, the user may establish a wireless connection between the computer 110a and the access point 112b. Once this connection is established, the streaming content from the Web server 134 may be received via the router 130, the access point 112b, and the wireless connection, and consumed by the computer or host device 110a.

It may be further desirable for the user of the computer 110a to listen to an audio portion of the streaming content on the headset 114a, or access other data. Accordingly, the user of the computer 110a may establish a short-range wireless connection with the headset 114a. Once the short-range wireless connection is established, and with suitable configurations on the computer enabled, the audio portion of the streaming content may be consumed by the headset 114a. In instances where such advanced communication systems are integrated or located within the host device 110a, the radio frequency (RF) generation may support fast-switching to enable support of multiple communication standards and/or advanced wideband systems like, for example, Ultrawideband (UWB) radio. The computer 110a may be an Internet Protocol (IP) endpoint device, which may communicate via the IP protocol with the web-server 134. In some instances, the computer 110a may be used to communicate real-time data, for example Voice over Internet Protocol (VoIP) speech data with the web-server 134. In some instances, web-server 134 may comprise another IP Endpoint, for example, a VoIP telephone. The data services at computer 110a may not be limited to any particular type of data, but may be arbitrary data, and may comprise, for example, voice data, video data, file sharing services, and text messaging services.

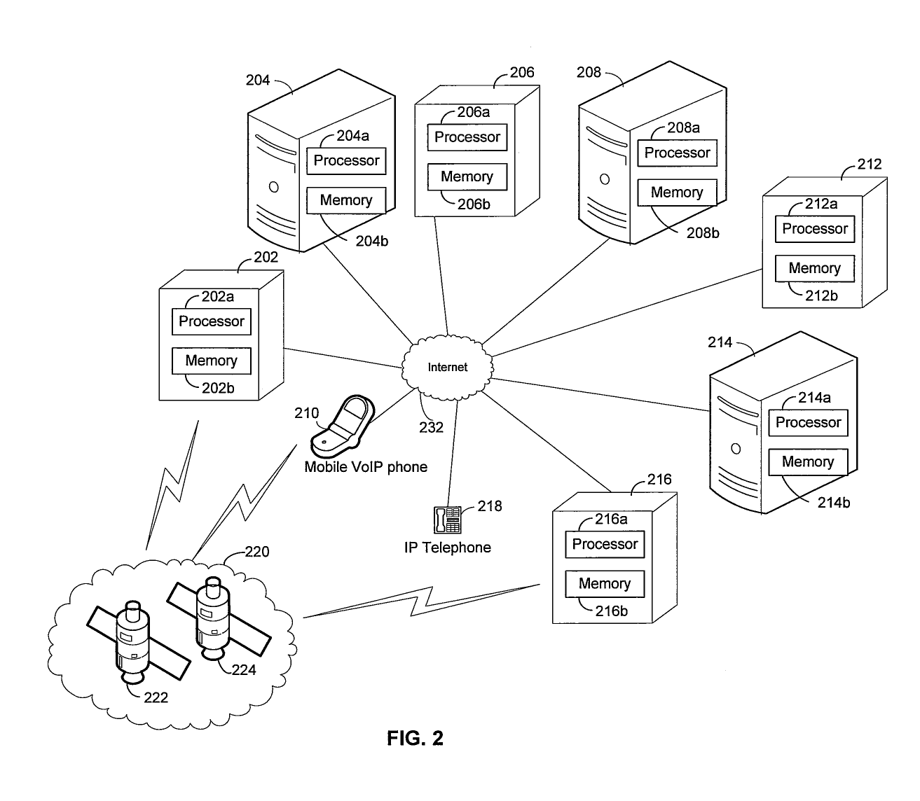

One or more devices in a communication network may comprise suitable logic, circuitry and/or code that may be enabled to receive and process GNSS 102 information, which may be broadcast via radio-frequency signals. For example, the host device 110a, and the web server 134 may comprise suitable logic, circuitry and/or code that may be enabled to process radio signals received from the GNSS 102. A host device 110a, for example, may process the radio-frequency signals from the GNSS 102 to establish its own location. In accordance with various embodiments of the invention, the location of one or more devices in a communication network may be used to improve communication performance as described in FIG. 2

FIG. 2 is an exemplary distributed VoIP network topology, in accordance with an embodiment of the invention. Referring to FIG. 2, there is shown a mobile VoIP phone 210, an IP telephone 218, proxy servers 202, 206, 212, and 216, Media servers 204, 208, and 214, the Internet 232, and a GNSS 220.

The proxy servers and media servers 202, 204, 206, 208, 212, 214, and 216 may each comprise a processor 202a, 204a, 206a, 208a, 212a, 214a, and 216a, and a memory 202b, 204b, 206b, 208b, 212b, 214b, and 216b, respectively. The processors 202a, 204a, 206a, 208a, 212a, 214a, and 216a may be similar and may comprise suitable logic, circuitry and/or logic that may be enabled to process signals to provide one or more services, and process communication data. The memory 202b, 204b, 206b, 208b, 212b, 214b, and 216b may comprise suitable logic, circuitry and/or code that may be enabled to store, and read and write data to the storage. The memory 202b, 204b, 206b, 208b, 212b, 214b, and 216b may be accessed, for example, by the processors 202a, 204a, 206a, 208a, 212a, 214a, and 216a, respectively. The GNSS 220 may comprise satellites 222 and 224. The satellites 222, 224 and the GNSS 220 may be substantially similar to the satellites 104, 106, and the GNSS 102.

The mobile VoIP phone 210 may comprise suitable logic, circuitry and/or code that may be enabled to operate as an IP endpoint device via a VoIP network. In some instances, the mobile VoIP pone 210 may operate over a wireless physical data link. The mobile VoIP phone 210 may be substantially similar to the host device 110a, and may be enabled to process communication signals, and GNSS radio frequency signal in accordance with various embodiments of the invention. The IP telephone 218 may be substantially similar to the mobile VoIP phone 210. The proxy servers 202, 206, 212, and 216 may comprise suitable logic, circuitry and/or code that may be enabled to route, assist, setup, operate, and terminate VoIP calls between two IP endpoints, for example the mobile VoIP phone 210 and the IP telephone 218. The proxy servers may operate in accordance with any signaling protocol, for example SIP (Session Initiation Protocol), which may be used to assist in VoIP call management. One or more of the proxy servers 202, 206, 212, and 216 may be enabled to determine their own location, for example by suitable processing of radio signals broadcast from the GNSS 102. A proxy server may also be referred to as a call server, CALL-S. The media servers (MED-S) 204, 208, and 214 may comprise suitable logic, circuitry and/or code that may be enabled to offer a media service to an IP endpoint device, for example to the IP telephone 218. The services that may be offered by the media servers may include, but are not limited to, voice mail service, streaming audio, file-sharing, text messaging and streaming video services, for example. One or more of the media servers 204, 208, and 214 may be enabled to determine their own location, for example by suitable processing of radio signals broadcast from the GNSS 102.

In many distributed VoIP system network topologies, the VoIP terminals, for example the mobile VoIP phone 210 and the IP telephone 218 may communicate with and via call servers, for example proxy servers 202, 206, 212, and 216 which may be used as call management service providers, for example. An IP endpoint device, for example the mobile VoIP phone 210, may request VoIP services from a proxy server, for example proxy server 206. The services requested by the IP endpoint and provided by the call server, may be communicated by using a signaling protocol, for example the SIP protocol. In addition to signaling messages that may be exchanged between the IP endpoint and the proxy server, it may be desirable to exchange media messages between the media servers and the IP endpoint in some instances, for example voice mail.

In a distributed VoIP system, a number of proxy servers and/or media servers may exist, and in some instances a plurality of servers may be able to provide a particular service to an IP endpoint device. In most instances, one server may be assigned to provide a service to the IP endpoint device. The server assignment for a particular service to an IP endpoint may be static or dynamic, in accordance with various embodiments of the invention, and changing network conditions.

In IP networks, transit times of packets from a first IP endpoint, for example the mobile VoIP phone 210, to a second IP endpoint, for example the IP telephone 218, may be affected by various parameters, for example physical separation distance, network congestion, and other network traffic characteristics. In many instances, the further the physical separation between the communicating IP endpoints may be, the greater the end-to-end delays that may be experienced. For example, in these instances, more routers and other network elements may be along the communications path, each of which may introduce certain delays. To the user employing a VoIP service via an IP endpoint device, the delay may significantly influence the call quality experienced (Quality of Experience=QoE). VoIP communication delays may result in longer call setup times, poor response time in accessing interactive services, for example voice mail, and communication delays in real-time services like voice, and near real-time services like instant messaging. Thus, to provide a certain level of QoE to the user, it may be desirable that the physically closest server to an IP endpoint may be selected, and assigned to provide VoIP telephony services, for example. This may be achieved if the physical location of the IP endpoints and the proxy servers, and the media servers may be known. IP endpoints, for example the mobile VoIP phone 210 and/or the IP Telephone 218, and servers, for example proxy servers and media servers 202, 204, 206, 208, 212, 214, and 216, may determine their physical location by processing signals received from the GNSS 220 via the satellites 222 and 224, for example. In accordance with various embodiments of the invention, the selection and assignment of the serving server (SER-S) providing a service may be automatic and/or transparent to the user.

The selection and assignment of the serving server SER-S may be made at a point-of-entry server (POE-S), which may be a server of first contact between the IP endpoint and the VoIP network, for example. For example, the mobile VoIP phone 210 may want to communicate to the IP telephone 218. The mobile VoIP phone 210 may initially contact the proxy server 206, the POE-S, and the proxy server 202 may be selected by the proxy server 206 to provide the VoIP service because it may be closest to the mobile VoIP phone 210 for the desired service. In addition, the mobile VoIP phone 210 may request voice mail service, and may be assigned to the media server 204, for example, by the POE-S 206. In accordance with various embodiments of the invention, the POE-S may be a dedicated POE-S, or may itself also provide certain VoIP services. Thus, the POE-S may comprise a proxy server, in some instances. In accordance with various embodiments of the invention the POE-S may comprise call signaling in some instances, and may comprise suitable logic, circuitry and/or code that may be enabled to provide authentication services. In some instances, the POE-S may comprise a SIP registrar.

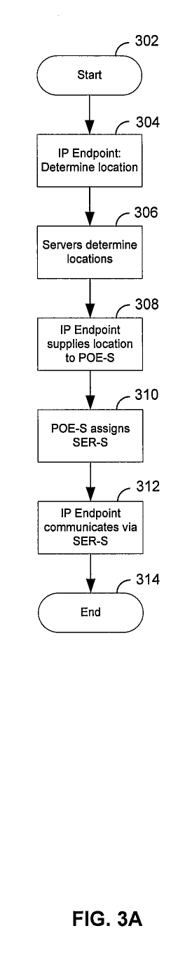

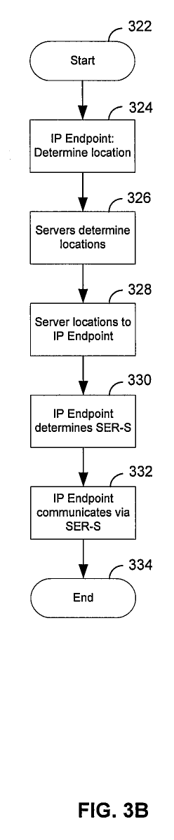

FIG. 3A is a flow chart illustrating an exemplary POE-S based server assignment protocol, in accordance with various embodiments of the invention. The protocol may be initialized in step 302, when an IP endpoint device, for example, the IP telephone 218, may initiate a request to a POE-S server to setup a communication session. This may be, for example, a SIP-based VoIP phone, and a SIP POE-S, which may also be referred to as a SIP registrar. A SIP registrar may comprise suitable logic, circuitry and/or code that may be enabled to perform user registration functions. In step 304, the IP endpoint device may determine its position through the use of a GNSS (Global Navigation Satellite System), for example, as described in FIG. 1 and FIG. 2. An exemplary GNSS system may be the Global Positioning System (GPS), GLONASS, and/or Galileo. In step 306, the proxy servers (CALL-S) and the media servers (MED-S) may similarly obtain their physical location information, and make it available to possible POE-S servers. This may be achieved via GNSS, or via manual provisioning, for example. Because most CALL-S and MED-S may be stationary, server location updates may be infrequent. In step 308, the IP endpoint may supply the POE-S with its physical location. Based on the location of the IP endpoint, and the location of the proxy servers (CALL-S) and Media servers (MED-S), the POE-S may determine to assign a certain CALL-S to handle the service request from the IP endpoint device. The assignment of a certain CALL-S to be a SER-S may be made based on a distance measure that may be computed at the POE-S in step 310. The distance measure may comprise physical distance between the IP endpoint and the CALL-S, and/or any other suitable parameters, for example congestion, round-trip-delays etc. For example, the distance may be a straight-line measure between the proxy servers and the IP endpoint. In step 312, the IP endpoint and the SER-S may then communicate directly and set up a VoIP call.

FIG. 3B is a flow chart illustrating an exemplary IP endpoint device based server assignment protocol, in accordance with various embodiments of the invention. The protocol may be initialized in step 322, when an IP endpoint device, for example, the IP telephone 218, may initiate a request to a POE-S server to setup a communication session. This may be, for example, a SIP-based VoIP phone, and a SIP POE-S, which may also be referred to as a SIP registrar. In step 324, the IP endpoint may determine its position through the use of GNSS (Global Position System), for example, as described in FIG. 1 and FIG. 2. In step 326, the proxy servers (CALL-S) and the media servers (MED-S) may similarly obtain their physical location information, and make it available. The server locations may be determined via GNSS, or via manual provisioning, for example. Because most CALL-S and MED-S may be stationary, server location updates may be infrequent. In step 328, the servers may supply the IP endpoint device with their physical location. Based on the location of the IP endpoint, and the location of the proxy servers (CALL-S) and Media servers (MED-S), the IP endpoint may determine to assign a certain CALL-S to handle the call request. The assignment of a certain CALL-S to be SER-S may be made based on a distance measure that may be computed at the IP endpoint in step 330. The distance measure may comprise physical distance between the IP endpoint and the CALL-S, and any other suitable parameters, for example congestion, round-trip-delays etc. In step 332, the IP endpoint and the SER-S may then communicate directly and set up a VoIP call.

In accordance with an embodiment of the invention, a method and system for GNSS-assisted Call Signaling and Multimedia server assignment may comprise determining a location of an IP endpoint device, for example, mobile VoIP phone 210 and a location of each of a plurality of proxy servers and/or media servers, for example proxy server 202, wherein at least the location of the IP endpoint device 210 may be determined via Global Navigation Satellite System (GNSS). A proxy server 202 and/or media server, for example, may be assigned to be a serving server from the plurality of proxy servers and/or media servers, as illustrated in FIG. 2, for example, for one or more multimedia services for an IP endpoint device, for example mobile VoIP phone 210. The assignment may be done based on at least the determined location of the IP endpoint device and the locations of the plurality of proxy servers and/or media servers, as described in FIG. 3A and FIG. 3B. The GNSS may be the Global Positioning System (GPS), for example. The IP endpoint device may be a mobile device, for example the mobile VoIP phone 210. A proxy server 202 and/or a media server, for example, that may be closer to the IP endpoint device, for example mobile VoIP phone 210 than any other one from the plurality of proxy servers and/or media servers, for example server 212, may be assigned to be the serving server. The closer proxy server 202 and/or media server, for example, may be determined based on straight-line location separation distance between the proxy server 202 and/or media servers and the IP endpoint device 210, for example. The multimedia services may be controlled via Session Initiation Protocol (SIP) signaling. The proxy server 202 and/or media server may be a Session Initiation Protocol (SIP) Registrar and/or a SIP Proxy server. The serving server may be selected at a point-of-entry server, as described in FIG. 3A. The serving server assignment may be performed at the IP endpoint device or at one or more of the plurality of proxy servers and/or media servers, as described in FIG. 3A and FIG. 3B. The assignment may be based on, for example, round-trip-delay and/or a congestion measure. At least the location of the IP endpoint device may be requested and/or received from the IP endpoint device.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for GNSS-assisted Call Signaling and Multimedia server assignment.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing communication signals, the method comprising:
determining a location of an IP endpoint device and a location of each of a plurality of proxy servers and/or media servers, wherein at least said location of said IP endpoint device is determined via a Global Navigation Satellite System (GNSS); and
assigning a proxy server and/or media server from said plurality of proxy servers and/or media servers to be a serving server for one or more multimedia services for an IP endpoint device, wherein said assigning is based on at least said determined location of said IP endpoint device and said locations of said plurality of proxy servers and/or media servers.

2. The method according to claim 1, wherein said GNSS is Global Positioning System (GPS).

3. The method according to claim 1, wherein said IP endpoint device is a mobile device and/or a fixed device.

4. The method according to claim 1, comprising assigning a proxy server and/or a media server that is closer to said IP endpoint device than any other one from said plurality of proxy servers and/or media servers to be said serving server.

5. The method according to claim 4, comprising determining said closer proxy server and/or media server based on straight-line location separation distance between said proxy server and/or media server and said IP endpoint device.

6. The method according to claim 1, wherein said multimedia services are controlled via Session Initiation Protocol (SIP) signaling.

7. The method according to claim 1, wherein said proxy server and/or media server is a Session Initiation Protocol (SIP) Registrar and/or a SIP Proxy server.

8. The method according to claim 1, comprising selecting said serving server at a point-of-entry server.

9. The method according to claim 1, wherein said assigning of said serving server is performed at said IP endpoint device or at one or more of said plurality of proxy servers and/or media servers.

10. The method according to claim 1, wherein said assigning is based on round-trip-delay and/or a congestion measure.

11. The method according to claim 1, comprising requesting said at least said location of said IP endpoint device from said IP endpoint device.

12. The method according to claim 1, comprising receiving said requested said at least said location of said IP endpoint device from said IP endpoint device.

13. A system for processing communication signals, the system comprising:
one or more processors operable to:
determine a location of an IP endpoint device and a location of each of a plurality of proxy servers and/or media servers, wherein at least said location of said IP endpoint device is determined via a Global Navigation Satellite System (GNSS); and
assign a proxy server and/or media server from said plurality of proxy servers and/or media servers to be a serving server for one or more multimedia services for an IP endpoint device, wherein said assigning is based on at least said determined location of said IP endpoint device and said locations of said plurality of proxy servers and/or media servers.

14. The system according to claim 13, wherein said GNSS is Global Positioning System (GPS).

15. The method according to claim 13, wherein said IP endpoint device is a mobile device and/or a fixed device.

16. The system according to claim 13, wherein said one or more processors assign a proxy server and/or media server that is closer to said IP endpoint device than any other one from said plurality of proxy servers and/or media servers to be said serving server.

17. The system according to claim 16, wherein said one or more processors determine said closer proxy server and/or media server based on straight-line location separation distance between said proxy server and said IP endpoint device.

18. The system according to claim 13, wherein said multimedia services are controlled via Session Initiation Protocol (SIP) signaling.

19. The system according to claim 13, wherein said proxy server is a Session Initiation Protocol (SIP) Registrar and/or a SIP Proxy server.

20. The system according to claim 13, wherein said one or more processors select said serving server at a point-of-entry server.

21. The system according to claim 13, wherein said assignment of said serving server is performed at said IP endpoint device or at one or more of said plurality of proxy servers.

22. The system according to claim 13, wherein said assignment is based on round-trip-delay and/or a congestion measure.

23. The system according to claim 13, wherein said one or more processors request said at least said location of said IP endpoint device from said IP endpoint device.

24. The system according to claim 13, wherein said one or more processors receive said requested said at least said location of said IP endpoint device from said IP endpoint device.
